(19) United States
(12) Patent Application Publication
(10) Pub. No.: US 2023/0375349 A1
(43) Pub. Date: Nov. 23, 2023

(54) DETERMINING CHARGING OF ELECTRIC DELIVERY VEHICLES

(71) Applicant: Liikennevirta Oy / Virta Ltd, Helsinki (FI)

(72) Inventor: Jussi Ahtikari, Helsinki (FI)

(21) Appl. No.: 18/246,839

(22) PCT Filed: Sep. 28, 2021
(86) PCT No.: PCT/FI2021/050635

§ 371 Date: Mar. 27, 2023

(30) Foreign Application Priority Data
Sep. 29, 2020 (FI) 20205939

(51) Int. Cl. G01C 21/34; B60L 58/10; B60L 53/62; G06Q 10/0835

(52) U.S. Cl. CPC G01C 21/343; G01C 21/3469; B60L 58/10; B60L 53/62; G06Q 10/08355; B60L 2240/60

(57) ABSTRACT

Various example embodiments generally relate to charging electric devices. There is determined a charging of an electronic delivery vehicle, EDV, configured to deliver a delivery. A delivery route of the delivery configured for the EDV is received. A delivery rule of the delivery is also received. A battery state of the EDV may also be received. Data information of available energy at charging stations may additionally be received. Based on the delivery route, the delivery rule, the battery state and the data information of the available energy, a plan is processed as to when and where to charge the EDV for the delivery. This solution may enable the delivery to be delivered in an optimal way with respect to the electric vehicle, what is being delivered and with respect to the available energy at the charging station. Apparatuses, methods, and computer programs are disclosed.

### TECHNICAL FIELD

Various example embodiments generally relate to the field of charging electric devices. In particular, some example embodiments relate to determining the charging of electric delivery vehicles.

### BACKGROUND

Different types of deliveries are growing constantly. People are more and more using different home delivery services instead of, for example, going to a shop to buy things. People order more food home instead of going to a restaurant, etc. There are many different kinds of delivery services: delivery of goods, for example orders from web shops; delivery of food and groceries, for example orders from restaurants or supermarkets; delivery of people, for example taxis, Uber, etc.

At the same time as delivery services are growing, more and more of the delivery vehicles are electric vehicles, EV, and they need to be charged somewhere.

One of the simplest ways to charge an electric delivery vehicle, EDV, is simply to go to a charging station when the battery starts to be empty. However, since charging will easily take at least 20-30 minutes even with a quick charger, charging when a battery is empty might create problems: amongst other things, an EDV cannot go charging for example in the middle of food delivery, because the food will get cold, or a taxi cannot go charging if a client is waiting for a pickup.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments of the present disclosure enable determination of charging for an EDV having the delivery considered. This and other benefits may be achieved by the features of the independent claims. Further implementation forms are provided in the dependent claims, the description, and the drawings.

According to a first aspect, an apparatus may be configured for determining a charging of an electronic delivery vehicle, EDV, configured to deliver a delivery. The apparatus is configured to receive a delivery route of the delivery configured for the EDV. It receives a delivery rule of the delivery. It may also receive a battery state of the EDV. It may additionally receive data information of available energy at charging stations. Based on the delivery route, the delivery rule, the battery state and the data information of the available energy, the apparatus may be configured to process a plan as to when and where to charge the EDV for the delivery. This solution may enable the delivery to be delivered in an optimal way with respect to the electric vehicle, what is being delivered and available energy at the charging station.

According to an implementation form of the first aspect, the plan comprises a location of at least one charging station, wherein the delivery route is configured based on the location of the at least one charging station. This solution may optimize the route also with respect to the location of the charging station.

According to an implementation form of the first aspect, the plan comprises a duration of the charging at the at least one charging station. This solution may enable optimization of the delivery with respect to time and battery state.

According to an implementation form of the first aspect, the plan comprises a point of time of performing the charging. This solution may take into consideration what kind of delivery is being delivered and adapt the timing of charging accordingly.

According to an implementation form of the first aspect, the delivery route of the EDV comprises at least one pickup location, at least one destination location, and a distance of the delivery route for the EDV. This solution may enable determination of physical characteristics of the route.

According to an implementation form of the first aspect, the delivery route of the EDV is determined by a logistics system with respect to the pickup location, destination location and a road network. This solution may enable use of external, or even existing, delivery or navigation routes, and configure a charging operation according to that.

According to an implementation form of the first aspect, the delivery rule comprises contents of what is being delivered, a type of the EDV which is used for the delivery, and a delivery priority. This solution may optimize charging with respect to the characteristics of the delivery.

According to an implementation form of the first aspect, the delivery priority comprises information for delivering: as soon as possible, as soon as the pickup destination is ready, within a promised delivery time, or whenever. This solution may optimize charging with respect to the characteristics of the delivery.

According to an implementation form of the first aspect, the input of the available energy comprises an electricity grid load state, an electricity price, or at least one source information of the available energy. This solution may take into consideration the characteristics of available energy for the charging operation.

According to an implementation form of the first aspect, the plan comprises depot charging instructions configured to depot charge the EDV when it is not doing deliveries but is parked to a depot. This solution may utilize depot charging with respect to the delivery.

According to an implementation form of the first aspect, the plan comprises mandatory charging instructions configured to order, during or in between the deliveries, the EDV to at least one charging station when the EDV cannot finish the current or future delivery routes without charging. This solution takes into consideration mandatory aspects of the battery and the delivery in order to conduct the delivery properly.

According to an implementation form of the first aspect, the plan comprises opportunity charging instructions configured to, during or in between the deliveries, instruct the EDV to be charged, even if it does not need extra energy to finish the current or planned delivery routes. This solution may take into consideration the flexibility of the delivery to take advantage of reasonable charging possibilities.

According to a second aspect, a method determines a charging of an electronic delivery vehicle, EDV, configured to deliver a delivery. There is received a delivery route of the delivery configured for the EDV. A delivery rule of the delivery is also received. A battery state of the EDV is received, and data information of available energy at charging stations is also received. Based on the delivery route, the delivery rule, the battery state and the data information of the available energy, there is processed a plan as to when and where to charge the EDV for the delivery.

According to a third aspect, a computer program is configured, when executed by an apparatus, to cause the apparatus at least to perform a method according to any implementation form of the second aspect.

According to a fourth aspect, an apparatus may comprise at least one processor; and at least one memory including computer program code; the at least one memory and the computer program code configured to, with the at least one processor, cause the apparatus at least to perform a method according to any implementation form of the second aspect.

It is appreciated that the implementation forms described above may be used in combination with each other. Several of the implementation forms may be combined to form a further implementation form.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of an electric vehicle charging system, according to an example embodiment;

FIG. 2 illustrates an example of an apparatus configured to practice one or more example embodiments;

FIG. 3 illustrates an example of a charging plan of an electric delivery vehicle, according to an example embodiment;

FIG. 4 illustrates an example of a delivery of an electric delivery vehicle, according to an example embodiment;

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

An electric delivery vehicle, EDV, can be used to deliver various kinds of deliveries from pickup locations to delivery destinations via an optimized delivery route. An apparatus receives a delivery route of the delivery that is configured for the EDV. The delivery route navigates the EDV from the pickup location(s) to delivery destination(s). The apparatus also receives a delivery rule for the delivery. The delivery rule may have data information about the contents and characteristics of the delivery. The apparatus also receives a battery state of the EDV. This may indicate a current status of the battery of the EDV, for example the amount of the charge left on the battery. The apparatus also receives data information of available energy at charging stations. Charging stations where the EDV may be charged provide data information in relation to the charging operation. The apparatus processes the received data information. Based on the delivery route, the delivery rule, the battery state and the data information of the available energy, the apparatus processes and outputs a plan as to when and where to charge the EDV for conducting the delivery.

For example, charging of the EDV may be optimized for the determined delivery route. A plan indicates to the EDV where it is appropriate to be charged, considering various factors in relation to the charging and delivery operations. The plan may also indicate when and for how long the EDV should be charged in relation to the charging and delivery operations.

The charging of EDVs may be divided into three different examples. A depot charging actualizes when the EDV is not doing deliveries but is parked to a depot. Typically, this may take place during the night or non-usage hours of the EDV. A mandatory charging is actualized during, or in between, the deliveries when the EDV cannot finish the current or future delivery route(s) without charging. An opportunity charging may be actualized during, or in between, the deliveries when the EDV is charged even if the EDV does not need extra energy to finish the current or planned delivery routes.

The apparatus is configured to determine what is an optimal time and location to do the mandatory charging. The apparatus is further configured to determine when and where the EDV should do the opportunity charging. The apparatus may be further configured to determine how the EDV should avoid charging at peak hours, when electricity usage should be avoided. Additionally, the apparatus may be configured to determine the optimal locations to install new charging stations, when typical delivery routes and schedules are given.

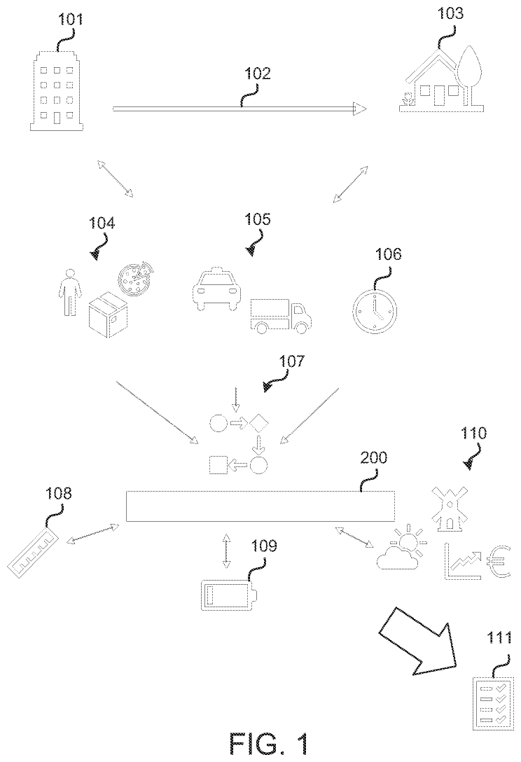

FIG. 1 illustrates an example of an electric vehicle charging system, according to an example embodiment.

A logistics system creates a delivery route 102. In the delivery route 102, deliveries are picked up from one location, a pickup location 101, and delivered to another, a delivery location 103, using the delivery route 102, which is created by the logistics system. The logistics system may be external to the apparatus 200, or alternatively incorporated into the apparatus 200.

Each delivery has delivery rules affecting the delivery. The delivery rules may be inputs for the delivery. The delivery rules comprise contents 104 of the delivery, a vehicle 105 of the delivery and a priority 106 of the delivery. Contents 104 describe what is being delivered, for example people, food, goods, etc. A vehicle 105 illustrates which kind of electric vehicle is used for the delivery. The delivery priority 106, alternatively referred to as deadline, illustrates time attributes affecting the delivery.

There may be different kinds of priorities for deliveries, or delivery priorities 106. For example, the delivery may need to be delivered as soon as possible. Another example is a taxi order or one-hour delivery from a web-shop. The delivery may need to be delivered as soon as the pickup destination 103 is ready. For example, a food delivery from a restaurant needs to be delivered as soon as the restaurant has finished making the food. The delivery may also need to be delivered within a promised delivery time. For example, a grocery shop could promise a delivery for the next day between 18:00-21:00, or a web-shop could promise a delivery within 14 days of the order. The delivery may also be actualized whenever the EDV picks the delivery. For example, many shops do not promise any specific delivery time, so the delivery vehicle is free to pick up and deliver the package whenever they want.

The apparatus 200 is configured to determine, by an optimization algorithm 107, the rules and constraints of the delivery. The apparatus 200 receives an additional input from different variables: a delivery distance 108 between the pickup location 101 to a destination 103 via a road network, a battery SoC 109, and an environmental input 110. The environmental input 110 has data information of availability of renewable electricity, such as solar and wind energy, electricity price, electric grid load.

As a result, the apparatus 200 is configured by the optimization algorithm 107 to create a plan 111 on where and when the EDV should be charged for conducting the delivery and considering characteristics of the delivery.

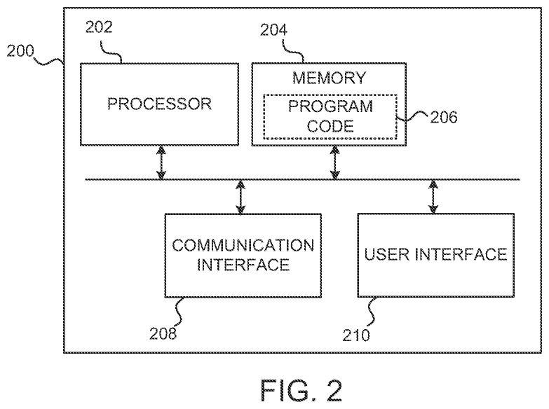

FIG. 2 illustrates an example embodiment of an apparatus 200 configured to practice one or more example embodiments. The apparatus 200 may comprise a computing device such as, for example, a server. Although the apparatus 200 is illustrated as a single device, it is appreciated that, wherever applicable, functions of the apparatus 200 may be distributed to a plurality of devices.

The apparatus 200 may comprise at least one processor 202. The at least one processor may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus may further comprise at least one memory 204. The memory may be configured to store, for example, computer program code or the like, for example operating system software and application software. The memory may comprise one or more volatile memory devices, one or more non-volatile memory devices, and/or a combination thereof. For example, the memory may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 200 may further comprise a communication interface 208 configured to enable the apparatus 200 to transmit and/or receive information to/from other apparatuses. The communication interface 208 may be configured to provide at least one wireless radio connection, such as for example a 3GPP mobile broadband connection (e.g. 3G, 4G, 5G). However, the communication interface may be configured to provide one or more other types of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The communication interface 208 may comprise, or be configured to be coupled to, at least one antenna to transmit and/or receive radio frequency signals. One or more of the various types of connections may be also implemented as separate communication interfaces, which may be coupled or configured to be coupled to a plurality of antennas. The communication interface may also comprise an internal communication interface within a system, such as for example a data bus.

The apparatus 200 may further comprise a user interface 210 comprising an input device and/or an output device. The input device may take various forms such as a keyboard, a touch screen, or one or more embedded control buttons. The output device may for example comprise a display, a speaker, a vibration motor, or the like.

When the apparatus 200 is configured to implement some functionality, some component and/or components of the apparatus, such as for example the at least one processor and/or the memory, may be configured to implement this functionality. Furthermore, when the at least one processor is configured to implement some functionality, this functionality may be implemented using program code 206 comprised, for example, in the memory 204.

The functionality described herein may be performed, at least in part, by one or more computer program product components such as software components. According to an embodiment, the apparatus comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

The apparatus 200 comprises means for performing at least one method described herein. In one example, the means comprise the at least one processor, the at least one memory including program code configured to, when executed by the at least one processor, cause the apparatus to perform the method.

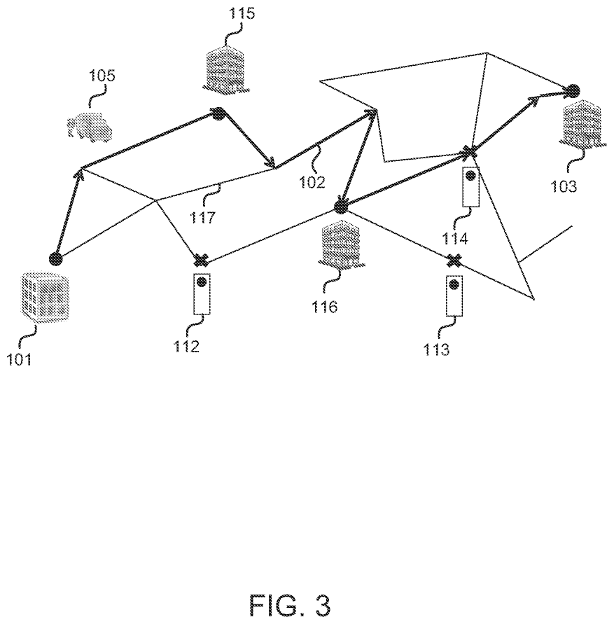

FIG. 3 illustrates an example of a charging plan 111 of an EDV, according to an example embodiment. The EDV has an original planned delivery route from a pickup location 101 to delivery destinations 115, 116 and finally 103. Charging stations 112, 113, and 114 are positioned along a road network 117 of the EDV. The plan 111 indicates that the EDV should stop to charge at charging station 114. The plan 111 may also indicate to ignore charging stations 112 and 113. The plan 111 may be based on the example embodiment of FIG. 1.

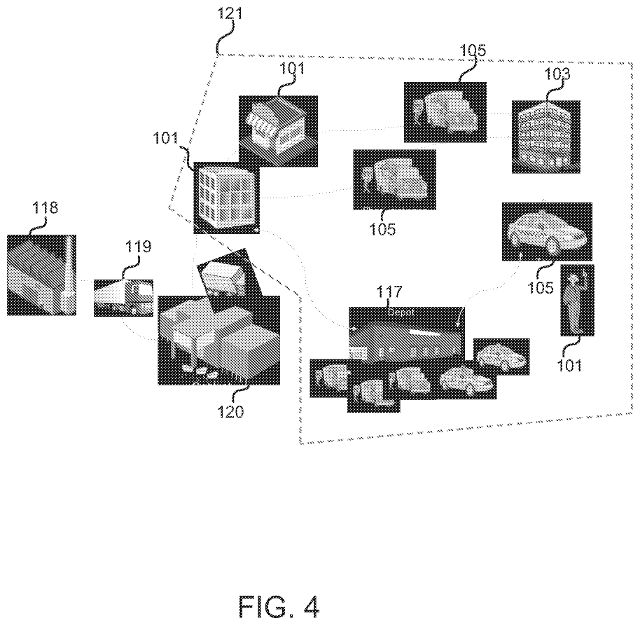

FIG. 4 illustrates an example of a delivery of an EDV, according to an example embodiment. Determination of charging in relation to the delivery may focus on short distance 121 deliveries of goods, food and people. Typically, this happens within a radius of some tens of kilometers. However, depending on the EDV and delivery itself, a longer distance may be applied. A factory 118, a long-distance delivery vehicle 119 and a central distribution center 120 typically provide the delivery to the pickup location 101. According to an embodiment, the EDV may operate as a long-distance delivery vehicle 119. However, typically the EDV operates for a short distance due to battery constrains. EDVs 105 move between different pickup 101 and delivery destinations 103 and often need to be charged at some point during the delivery operations. EDVs may typically go back to a depot 117 during the night, and possibly between deliveries, and may also be charged there.

Further features of the process directly result for example from functionalities of the apparatus 200 and possibly other devices, as described throughout the specification and in the appended claims. Different variations of the process may be also applied, as described in connection with the various example embodiments.

An apparatus 200 may be configured to perform or cause performance of any aspect of the process described herein. Further, a computer program may comprise instructions for causing, when executed, an apparatus to perform any aspect of the process described herein. Further, an apparatus may comprise means for performing any aspect of the process described herein. According to an example embodiment, the means comprises at least one processor, and memory including program code, the at least one processor, and program code configured to, when executed by the at least one processor, cause performance of any aspect of the process.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item, ‘at least one’ item, and ‘one or more’ items may refer to one or more of those items or a plurality of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

Although subjects may be referred to as ‘first’ or ‘second’ subjects, this does not necessarily indicate any order or importance of the subjects. Instead, such attributes may be used solely for the purpose of making a difference between subjects.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus for determining a charging of an electronic delivery vehicle, EDV, configured to deliver a delivery, the apparatus configured to:
receive a delivery route of the delivery configured for the EDV via a road network;
receive a delivery rule of the delivery;
receive a battery state of the EDV; and
receive data information of available energy at charging stations; and
based on the delivery route, the delivery rule, the battery state and the data information of the available energy, process a plan as to when and where to charge the EDV for the delivery, wherein the plan comprises opportunity charging instructions configured to, during or in between the deliveries, instruct the EDV to be charged, even if it does not need extra energy to finish current or planned delivery routes.

2. The apparatus according to claim 1, wherein the plan comprises:
a location of at least one charging station, wherein the delivery route is configured based on the location of the at least one charging station.

3. The apparatus according to claim 2, wherein the plan comprises:
a duration of the charging at the at least one charging station.

4. The apparatus according to claim 1, wherein the plan comprises:
a point of time of performing the charging.

5. The apparatus according to claim 1, wherein the delivery route of the EDV comprises at least one pickup location, at least one destination location, and a distance of the delivery route for the EDV via the road network.

6. The apparatus according to claim 5, wherein the delivery route of the EDV is determined by a logistics system with respect to the pickup location, destination location and the road network.

7. The apparatus according to claim 1, wherein the delivery rule comprises contents of what is being delivered, a type of the EDV which is used for the delivery, and a delivery priority.

8. The apparatus according to claim 7, wherein the delivery priority comprises information for delivering:
as soon as possible,
as soon as the pickup destination is ready,
within a promised delivery time, or
whenever.

9. The apparatus according to claim 1, wherein an input of the available energy comprises an electricity grid load state, an electricity price, or at least one source information of the available energy.

10. The apparatus according to claim 1, wherein the plan comprises:
depot charging instructions configured to depot charge the EDV when it is not doing deliveries but is parked to a depot.

11. The apparatus according to claim 1, wherein the plan comprises:
mandatory charging instructions configured to order, during or in between the deliveries, the EDV to at least one charging station when the EDV cannot finish the current or future delivery routes without charging.

12. A method for determining a charging of an electronic delivery vehicle, EDV, configured to deliver a delivery, comprising:
receiving a delivery route of the delivery configured for the EDV;
receiving a delivery rule of the delivery;
receiving a battery state of the EDV; and
receiving data information of available energy at charging stations; and
based on the delivery route, the delivery rule, the battery state and the data information of the available energy, processing a plan as to when and where to charge the EDV for the delivery, wherein the plan comprises opportunity charging instructions configured to, during or in between the deliveries, instruct the EDV to be charged, even if it does not need extra energy to finish current or planned delivery routes.

13. (canceled)
